(19) United States
(12) Patent Application Publication
(10) Pub. No.: US 2016/0057686 A1
(43) Pub. Date: Feb. 25, 2016

(54) INTER RADIO ACCESS TECHNOLOGY (IRAT) CELL RESELECTION

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/465,728

(22) Filed: Aug. 21, 2014

(51) Int. Cl. H04W 36/30; H04W 48/16; H04W 36/00

(52) U.S. Cl. CPC H04W 36/30; H04W 36/0088; H04W 36/0016; H04W 48/16; H04W 36/005

(57) ABSTRACT

A method for cell reselection includes camping on a first cell in response to detecting the first cell during a first background search. The method also includes recording an IRAT cell reselection serving cell threshold and reselecting a second cell of a second RAT when the first cell of the first RAT is below the threshold and the second cell of the second RAT is above a threshold. The method further includes detecting a second cell of the first RAT in response to performing a second background search and comparing a signal quality of the second cell with a sum of the recorded threshold and a predefined threshold value. The method still further includes on the second cell when the signal quality of the second cell exceeds the threshold plus a predefined threshold.

### BACKGROUND

1. Field

Aspects of the present disclosure relate generally to wireless communication systems, and more particularly, to cell reselection in a wireless network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes camping on a first cell of a first radio access technology (RAT) in response to detecting the first cell during a first background search of the first RAT. The method also includes recording an inter-radio access technology (IRAT) cell reselection serving cell threshold received from the first cell. The method includes reselecting to a second cell of a second RAT when the first cell of the first RAT is below the IRAT cell reselection serving cell threshold and the second cell of the second RAT is above an IRAT cell reselection neighbor cell threshold. The method further includes detecting a second cell of the first RAT in response to performing a subsequent second background search of the first RAT and comparing a signal quality of the second cell with a sum of the recorded IRAT cell reselection serving cell threshold and a predefined threshold. The method also includes camping on the second cell only when the signal quality of the second cell exceeds the IRAT cell reselection serving cell threshold plus the predefined threshold.

Another aspect discloses an apparatus including means for camping on a first cell of a first radio access technology (RAT) in response to detecting the first cell during a first background search of the first RAT. The apparatus also includes means for recording an inter-radio access technology (IRAT) cell reselection serving cell threshold received from the first cell. Also included in the apparatus is means for reselecting to a second cell of a second RAT when the first cell of the first RAT is below the IRAT cell reselection serving cell threshold and the second cell of the second RAT is above an IRAT cell reselection neighbor cell threshold. The apparatus also includes means for detecting a second cell of the first RAT in response to performing a subsequent second background search of the first RAT and means for comparing a signal quality of the second cell with a sum of the recorded IRAT cell reselection serving cell threshold and a predefined threshold. Further, the apparatus includes means for camping on the second cell only when the signal quality of the second cell exceeds the IRAT cell reselection serving cell threshold plus the predefined threshold.

Another aspect discloses wireless communication having a memory and at least one processor coupled to the memory. The processor(s) is configured to camp on a first cell of a first radio access technology (RAT) in response to detecting the first cell during a first background search of the first RAT. The processor is also configured to record an inter-radio access technology (IRAT) cell reselection serving cell threshold received from the first cell. The processor is also configured to reselect to a second cell of a second RAT when the first cell of the first RAT is below the IRAT cell reselection serving cell threshold and the second cell of the second RAT is above an IRAT cell reselection neighbor cell threshold. The processor is further configured to detect a second cell of the first RAT in response to performing a subsequent second background search of the first RAT and is configured to compare a signal quality of the second cell with a sum of the recorded IRAT cell reselection serving cell threshold and a predefined threshold. The processor is also configured to camp on the second cell only when the signal quality of the second cell exceeds the IRAT cell reselection serving cell threshold plus the predefined threshold.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of camping on a first cell of a first radio access technology (RAT) in response to detecting the first cell during a first background search of the first RAT. The program code also causes the processor(s) to record an inter-radio access technology (IRAT) cell reselection serving cell threshold received from the first cell. The program code also causes the processor(s) to reselect to a second cell of a second RAT when the first cell of the first RAT is below the IRAT cell reselection serving cell threshold and the second cell of the second RAT is above an IRAT cell reselection neighbor cell threshold. The program code also causes the processor(s) to detect a second cell of the first RAT in response to performing a subsequent second background search of the first RAT and to compare a signal quality of the second cell with a sum of the recorded IRAT cell reselection serving cell threshold and a predefined threshold. The program code also causes the processor(s) to camp on the second cell only when the signal quality of the second cell exceeds the IRAT cell reselection serving cell threshold plus the predefined threshold.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a call flow diagram illustrating cell reselection according to aspects of the present disclosure.

FIG. 6 is a block diagram illustrating a method for cell reselection according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

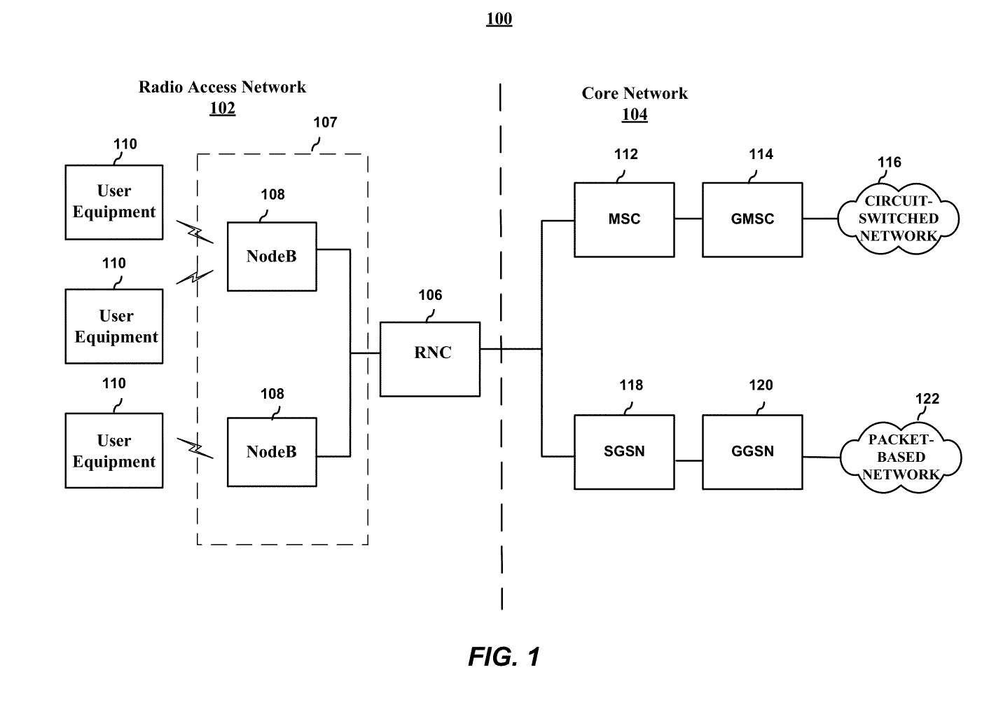

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

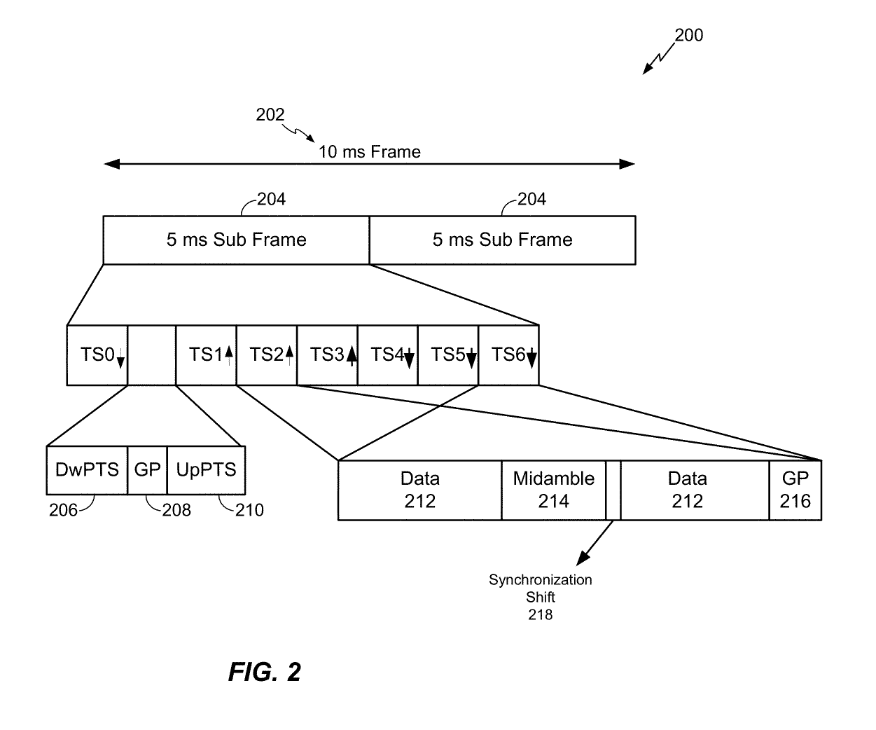

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

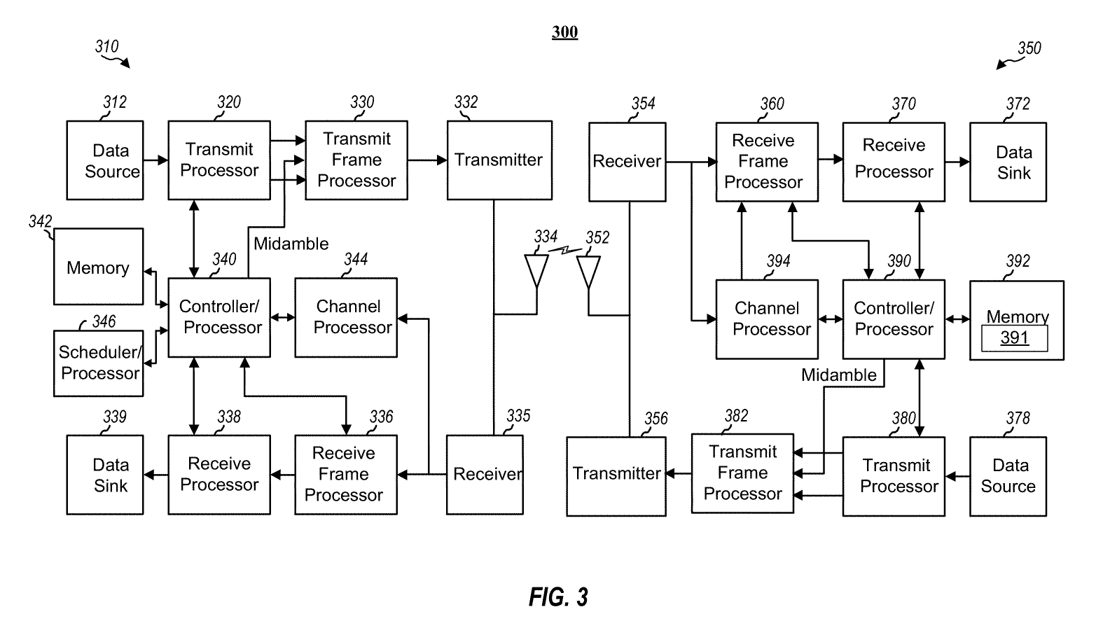

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. In particular, for example, the memory 392 of the UE 350 may store a cell reselection module 391 which, when executed by the controller/processor 390, configures the UE 350 for cell reselection. A scheduler/processor 346 at the node B 310 may be used to allocate resources to the UEs and schedule downlink and/or uplink transmissions for the UEs.

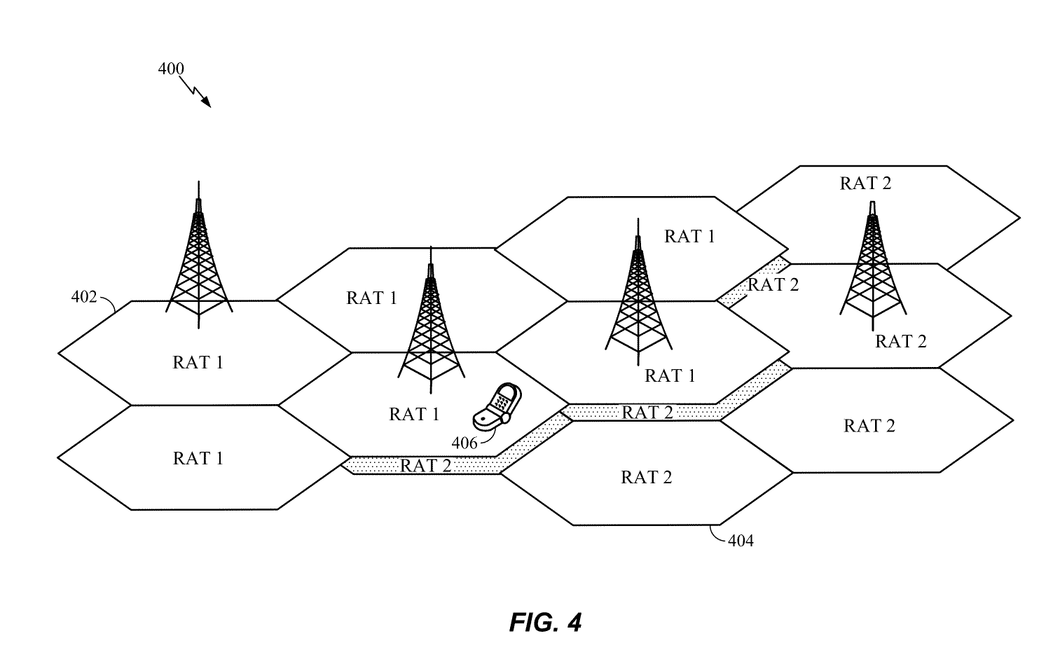

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as a 2G and/or 3G network and also illustrates a newly deployed network utilizing a second type of radio access technology (RAT-2), such as a 4G network. Those skilled in the art will appreciate that the RATs may include any type of network, such as, but not limited to, GSM, LTE, TD-SCDMA, high speed data networks, etc.

The geographical area 400 may include RAT-1 cells 402 and RAT-2 cells 404. In one example, the RAT-1 cells are 2G/3G cells and the RAT-2 cells are 4G cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., 2G/3G) a UE may be specified to perform a measurement of a neighboring cell (such as a 4G/LTE cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Handover from the first RAT to the second RAT may be based on event 3A measurement reporting. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a Primary Common Control Physical Channel (P-CCPCH) or a Primary Common Control Physical Shared Channel (P-CCPSCH) received signal code power (RSCP) measurement of a serving cell. Other filtered measurements can be of a received signal strength indication (RSSI) of a cell of the second RAT.

### IRAT Cell Reselection

When a UE is camped on a 2G or 3G cell, autonomous LTE scans are only performed when the 2G or 3G cell is not broadcasting LTE neighbor cells. The autonomous scans may be customized for a particular public land mobile network (PLMN), and can be turned on/off for specific operators. The benefit of turning this feature on for specific operators is that once the UE is camped on the 2G or 3G cell, the PLMN ID of that cell becomes known. Consequently, the equivalent home PLMN ID (EHPLMN ID) of that mobile network is also known from the EHPLMN IDs stored in the UE's local memory and/or SIM/U-SIM card. The autonomous scans of the LTE network can be customized for a particular mobile operator's network by scanning for specific LTE bands associated with that mobile operator's LTE network.

The LTE 3GPP specifications support approximately forty LTE frequency bands. Scanning for all forty of these frequency bands consumes time and battery power. The autonomous scans can be customized for each mobile operator using the EHPLMN ID matching the network on which the mobile user is camped. The customized scans are then performed only for the LTE bands deployed in that mobile operator's PLMN, based on the pre-configured LTE radio frequency (RF) bands for that operator. For example, an operator having 4 LTE frequency bands can limit such scans to 4 LTE bands and not scan all forty of the 3GPP LTE bands. Once an LTE cell is found, if its minimum quality (i.e., S-criteria) is met, and the PLMN-ID matches the EHPLMN IDs of the network on which the UE is currently camped, then the UE performs cell reselection and camps on the LTE cell.

During initial LTE deployment, such as hot spot deployment, the LTE coverage may be limited as compared to the 2G or 3G coverage, as seen in FIG. 4. Thus, if the UE is in an area having weak LTE coverage and strong 2G or 3G coverage, the UE may ping pong between services. In particular, while the UE is camped on a 2G/3G cell (e.g., GSM or TD-SCDMA/WCDMA cell), a function within the UE (e.g., NAS, non-access stratum layer) periodically sends commands to the UE Layer-3 (access stratum related, e.g. TDS RRC layer or GSM RR layer) to start a background PLMN scan to target 4G (e.g., LTE) frequencies. Once an LTE cell is found, if its signal quality criteria is met, the UE selects to the LTE cell.

After camping on the selected LTE cell, the UE immediately reselects back to 3G/2G, when the serving LTE cell signal strength and/or quality is below a serving LTE threshold (e.g., serving threshold equals q-RxLevMin+threshServingLow) and the 3G/2G neighbor cell strength and/or quality is above a neighbor 3G/2G threshold (e.g., neighbor threshold equals q-RxLevMin+threshX-Low). The aforementioned thresholds and the 3G/2G neighbor cells are broadcast from the LTE network. This repeating ping pong behavior significantly consumes UE battery, and also introduces signaling load as the UE continuously performs registration procedures. Further, the UE may miss pages as a result of the ping ponging.

One aspect of the present disclosure is directed to avoiding a ping pong effect. For example, when the UE camps on a 4G cell (e.g., LTE cell), the UE records the 4G serving threshold for the LTE cell through periodic background public land mobile network (BPLMN) searches. After the UE reselects back to 3G/2G, and after performing another BPLMN search, the UE performs cell selection to 4G only when the signal quality of the 4G cell is above a threshold related to the serving threshold for the LTE cell. Otherwise, if the signal quality of the 4G cell is below this threshold, the UE does not perform cell reselection to 4G. Use of this stored threshold prevents further repeating of the ping pong cell reselection between the strong 3G/2G cell and weak 4G cell. In one aspect, the value of the threshold is the recorded serving LTE threshold plus a UE internal predefined threshold (e.g., 3 dB.)

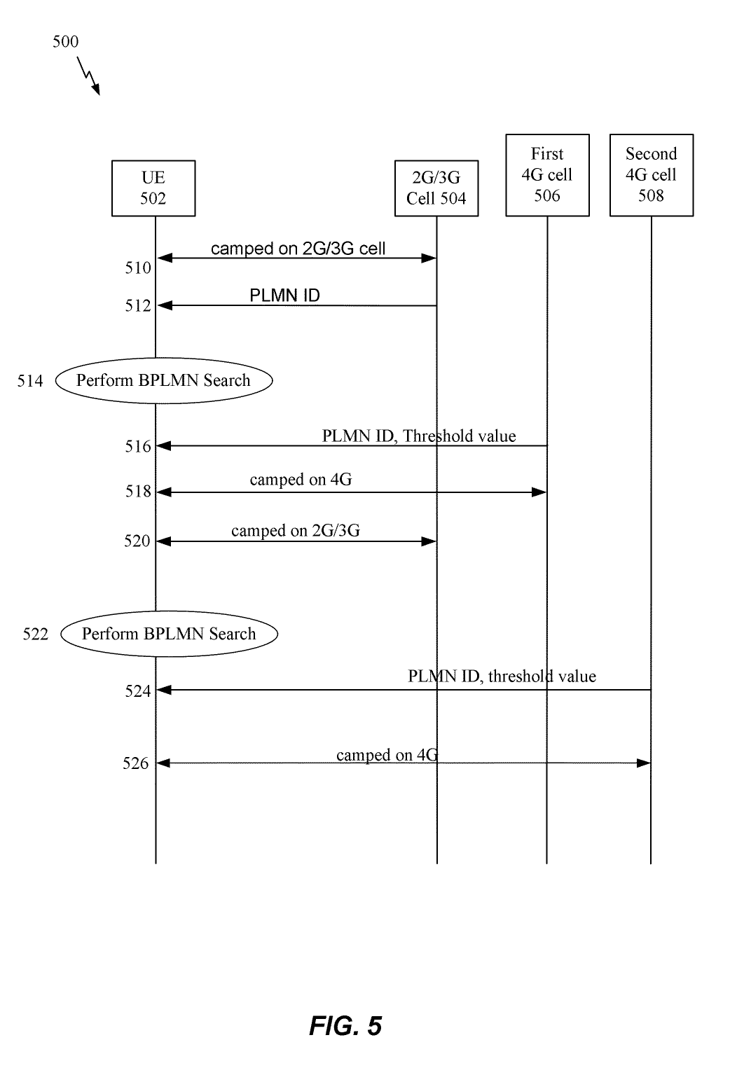

FIG. 5 is a call flow diagram 500 illustrating an example cell reselection by a UE 502 between a 2G/3G cell 504 and 4G cells 506 and 508. At time 510, the UE 502 is camped on the 2G/3G cell 504. The 2G/3G cell 504 transmits a PLMN ID to the UE 502 at time 512, and the UE has not received a neighbor list at this time. That is, the background search (e.g., BPLMN search) is performed when the UE 502 is camped on the 2G/3G cell 504 and the 2G/3G cell 504 does not broadcast a neighbor list of 4G cells.

Next, at time 514, the UE 502 performs a background search (e.g., BPLMN search) to locate one or more 4G cells. Once the first 4G cell 506 is located, the cell 506 broadcasts various information, such as network information, including the network ID (e.g., PLMN ID) and a reselection threshold for the serving 2G/3G cell 504. At time 516, the UE 502 receives and records the broadcast information which includes the cell reselection serving cell threshold. The UE 502 then moves to the first 4G cell 506 at time 518 and determines whether the signal quality of the cell 506 is above the threshold. If the signal quality is not above the threshold, the UE 502 returns to 2G/3G cell 504 at time 520.

At time 522, the UE 502 performs a subsequent background search (e.g. BPLMN search) to locate other 4G cells. At time 524, the UE 502 locates a second 4G cell 508 and receives information broadcast from the cell 508. The broadcast information includes a PLMN ID and threshold. The UE 502 then compares the signal quality of the second 4G cell 508 to the recorded threshold. If the signal quality of the second LTE cell 508 is greater than the threshold, the UE 502 camps on the second 4G cell 508 at time 526. It is contemplated that the second 4G cell 508 is the same as the first 4G cell 506, for example, when the UE has moved and the signal quality changes.

In one aspect of the present disclosure, the value of the threshold is the sum of the recorded threshold and a predefined value. Additionally, the predefined value may be determined by a UE 502 and may be adjusted based on the signal quality of the serving cell (e.g., 2G/3G cell 504). In one example, the predefined value is low when the signal quality of the serving cell 504 is low. Likewise, the predefined value is higher when the signal quality of the serving cell 504 is higher. Further, the predefined value may be adjusted based on the 2G/3G cell 504, 4G cells 506/508 and/or a frequency priority.

FIG. 5 illustrates an example of cell selection utilizing different radio access technologies. In particular, cell 504 is a 2G/3G cell and cells 506 and 508 are 4G cells. In another aspect, not shown, the cells may be from the same RAT.

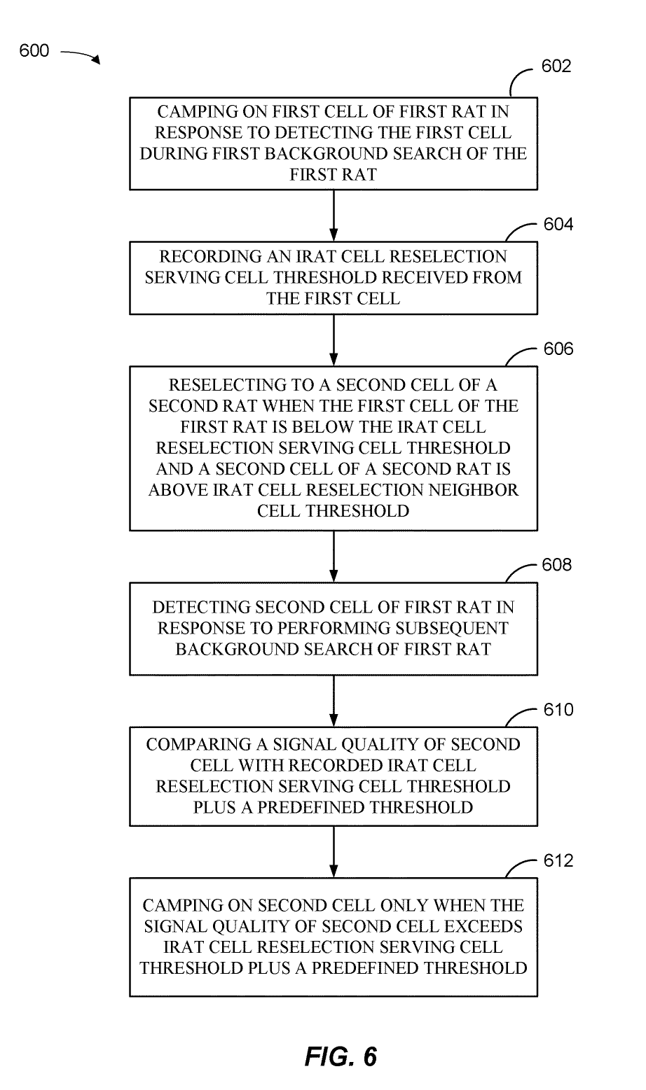

FIG. 6 shows a wireless communication method 600 according to one aspect of the disclosure. In block 602, a UE camps on a first cell of a first radio access technology (RAT) (e.g., LTE) in response to detecting the first cell during a first background search of the first RAT. The UE records an inter-radio access technology (IRAT) cell reselection serving cell threshold received from the first cell, in block 604. Next, in block 606, the UE reselects to a second cell of a second RAT (e.g., 2G/3G) when the first cell of the first RAT is below the IRAT cell reselection serving cell threshold and the second cell of a second RAT is above an IRAT cell reselection neighbor cell threshold.

The UE detects a second cell of the first RAT in response to performing a subsequent background search of the first RAT, as shown in block 608. In block 610, the UE compares a signal quality of the second cell with a sum of the recorded IRAT cell reselection serving cell threshold and a predefined threshold. The UE camps on the second cell only when the signal quality of the second cell exceeds the IRAT cell reselection serving cell threshold plus the predefined threshold, as shown in block 612.

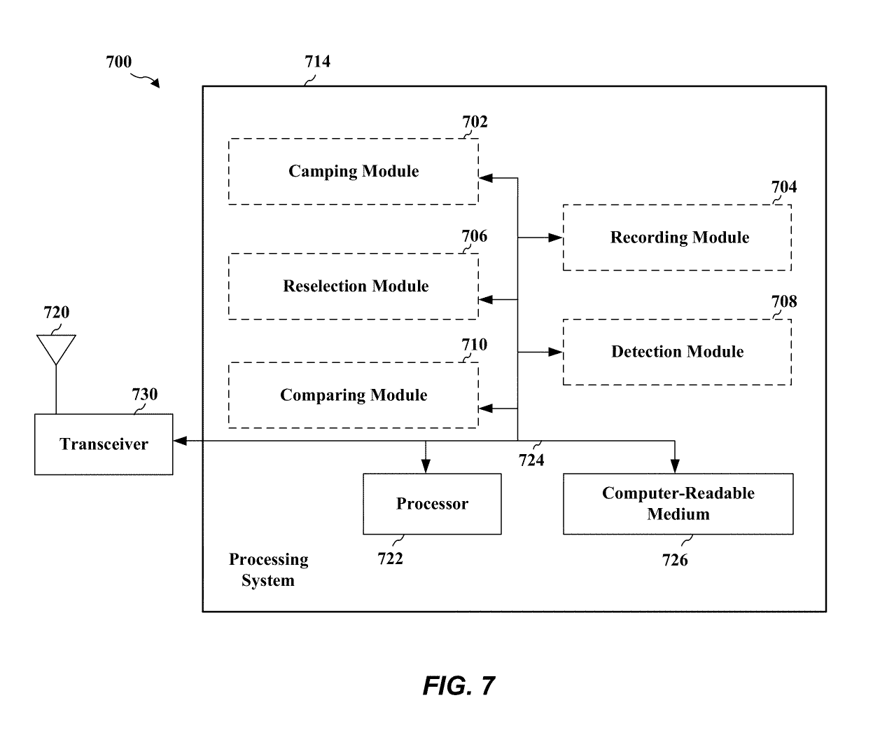

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, 706, 708, 710 and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a camping module 702 for camping on a first and/or second cell. The processing system 714 includes a recording module 704 for recording threshold values received from cells. The processing system 714 includes a reselection module 706 for reselecting from a first cell to a second cell. The processing system 714 includes a detection module 708 for detecting a second cell after performing a subsequent background search. The processing system 714 includes a comparing module 710 for comparing cell signal qualities to recorded threshold values. The modules may be software modules running in the processor 722, resident/stored in the computer readable medium 726, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for camping. In one aspect, the camping means may be the controller/processor 390, the memory 392, cell selection module 391, camping module 702, and/or the processing system 714 configured to perform the camping means. The UE is also configured to include means for recording In one aspect, the recording means may be the controller/processor 390, the memory 392, cell selection module 391, recording module 704, and/or the processing system 714 configured to perform the recording means. The UE is also configured to include means for reselecting In one aspect, the reselecting means may be the antennas 352, the receiver 354, the channel processor 394, the receive frame processor 360, the receive processor 370, the transmitter 356, the transmit frame processor 382, the transmit processor 380, the controller/processor 390, the memory 392, cell selection module 391, reselection module 706 and/or the processing system 714 configured to perform the reselecting means. The UE is also configured to include means for detecting In one aspect, the detecting means may be the antennas 352, the receiver 354, the channel processor 394, the receive frame processor 360, the receive processor 370, the transmitter 356, the transmit frame processor 382, the transmit processor 380, the controller/processor 390, the memory 392, cell selection module 391, detection module 708, and/or the processing system 714 configured to perform the detecting means. The UE is also configured to include means for comparing. In one aspect, the recording means may be the controller/processor 390, the memory 392, cell selection module 391, comparing module 710, and/or the processing system 714 configured to perform the comparing means. In one configuration, the means correspond to the aforementioned structures. In another aspect, the aforementioned means may be any module or any apparatus configured to perform the functions recited by the aforementioned means.

Several aspects of a telecommunications system has been presented with reference to 2G, 3G and 4G systems, such as but not limited to GSM, TD-SCDMA and LTE systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
camping on a first cell of a first radio access technology (RAT) in response to detecting the first cell during a first background search of the first RAT;
recording an inter-radio access technology (IRAT) cell reselection serving cell threshold received from the first cell;
reselecting to a second cell of a second RAT when the first cell of the first RAT is below the IRAT cell reselection serving cell threshold and the second cell of the second RAT is above an IRAT cell reselection neighbor cell threshold;
detecting a second cell of the first RAT in response to performing a subsequent second background search of the first RAT;
comparing a signal quality of the second cell of the first RAT with a sum of the recorded IRAT cell reselection serving cell threshold and a predefined threshold; and
camping on the second cell of the first RAT only when the signal quality of the second cell exceeds the IRAT cell reselection serving cell threshold plus the predefined threshold.

2. The method of claim 1, in which the first background search occurs when a user equipment (UE) is camped on a serving cell of the second RAT and the serving cell does not broadcast a neighbor list for the first RAT.

3. The method of claim 1, in which the predefined threshold is determined by a user equipment (UE), and is adjusted based on the signal quality of a serving cell of the second RAT.

4. The method of claim 1, in which the predefined threshold is determined by a user equipment (UE), and is adjusted based on at least one of, the first RAT, the second RAT, and a frequency priority.

5. The method of claim 1, in which the first RAT is 4G and the second RAT is 2G or 3G.

6. An apparatus for wireless communication, comprising:
means for camping on a first cell of a first radio access technology (RAT) in response to detecting the first cell during a first background search of the first RAT;
means for recording an inter-radio access technology (IRAT) cell reselection serving cell threshold received from the first cell;
means for reselecting to a second cell of a second RAT when the first cell of the first RAT is below the IRAT cell reselection serving cell threshold and the second cell of the second RAT is above an IRAT cell reselection neighbor cell threshold;
means for detecting a second cell of the first RAT in response to performing a subsequent second background search of the first RAT;
means for comparing a signal quality of the second cell of the first RAT with a sum of the recorded IRAT cell reselection serving cell threshold and a predefined threshold; and
means for camping on the second cell of the first RAT only when the signal quality of the second cell exceeds the IRAT cell reselection serving cell threshold plus the predefined threshold.

7. The apparatus of claim 6, in which the first background search occurs when a user equipment (UE) is camped on a serving cell of the second RAT and the serving cell does not broadcast a neighbor list for the first RAT.

8. The apparatus of claim 6, in which the predefined threshold is determined by a user equipment (UE), and is adjusted based on the signal quality of a serving cell of the second RAT.

9. The apparatus of claim 6, in which the predefined threshold is determined by a user equipment (UE), and is adjusted based on at least one of, the first RAT, the second RAT, and a frequency priority.

10. The apparatus of claim 6, in which the first RAT is 4G and the second RAT is 2G or 3G.

11. An apparatus for wireless communication, comprising:
a memory; and
at least one processor coupled to the memory, the at least one processor being configured:
to camp on a first cell of a first radio access technology (RAT) in response to detecting the first cell during a first background search of the first RAT;
to record an inter-radio access technology (IRAT) cell reselection serving cell threshold received from the first cell;
to reselect to a second cell of a second RAT when the first cell of the first RAT is below the IRAT cell reselection serving cell threshold and the second cell of the second RAT is above an IRAT cell reselection neighbor cell threshold;
to detect a second cell of the first RAT in response to performing a subsequent second background search of the first RAT;
to compare a signal quality of the second cell of the first RAT with a sum of the recorded IRAT cell reselection serving cell threshold and a predefined threshold; and
to camp on the second cell of the first RAT only when the signal quality of the second cell of the first RAT exceeds the IRAT cell reselection serving cell threshold plus the predefined threshold.

12. The apparatus of claim 11, in which the first background search occurs when a user equipment (UE) is camped on a serving cell of the second RAT and the serving cell does not broadcast a neighbor list for the first RAT.

13. The apparatus of claim 11, in which the predefined threshold is determined by a user equipment (UE), and is adjusted based on the signal quality of a serving cell of the second RAT.

14. The apparatus of claim 11, in which the predefined threshold is determined by a user equipment (UE), and is adjusted based on at least one of, the first RAT, the second RAT, and a frequency priority.

15. The apparatus of claim 11, in which the first RAT is 4G and the second RAT is 2G or 3G.

16. A computer program product for wireless communication in a wireless network, comprising:
a non-transitory computer-readable medium having non-transitory program code recorded thereon, the program code comprising:
program code to camp on a first cell of a first radio access technology (RAT) in response to detecting the first cell during a first background search of the first RAT;
program code to record an inter-radio access technology (IRAT) cell reselection serving cell threshold received from the first cell;
program code to reselect to a second cell of a second RAT when the first cell of the first RAT is below the IRAT cell reselection serving cell threshold and the second cell of the second RAT is above an IRAT cell reselection neighbor cell threshold;
program code to detect a second cell of the first RAT in response to performing a subsequent second background search of the first RAT;
program code to compare a signal quality of the second cell of the first RAT with a sum of the recorded IRAT cell reselection serving cell threshold and a predefined threshold; and
program code to camp on the second cell of the first RAT only when the signal quality of the second cell exceeds the IRAT cell reselection serving cell threshold plus the predefined threshold.

17. The computer program product of claim 16, in which the first background search occurs when a user equipment (UE) is camped on a serving cell of the second RAT and the serving cell does not broadcast a neighbor list for the first RAT.

18. The computer program product of claim 16, in which the predefined threshold is determined by a user equipment (UE), and is adjusted based on the signal quality of a serving cell of the second RAT.

19. The computer program product of claim 16, in which the predefined threshold is determined by a user equipment (UE), and is adjusted based on at least one of, the first RAT, the second RAT, and a frequency priority.

20. The computer program product of claim 16, in which the first RAT is 4G and the second RAT is 2G or 3G.
